(19) United States
(12) Patent Application Publication
(10) Pub. No.: US 2017/0175906 A1
(43) Pub. Date: Jun. 22, 2017

(54) FLUID-HANDLING COMPONENTS AND METHODS OF MANUFACTURE

(71) Applicant: Cameron International Corporation, Houston, TX (US)

(72) Inventors: Jerry A. Martino, Houston, TX (US); Declan Elliott, Longford (IE); Gopalakrishna Srinivasamurthy Magadi, The Woodlands, TX (US); Terry Lynn Clancy, Cypress, TX (US)

(21) Appl. No.: 15/226,912

(22) Filed: Aug. 2, 2016

Related U.S. Application Data
(63) Continuation of application No. 14/978,435, filed on Dec. 22, 2015.

(51) Int. Cl. F16K 3/24; B33Y 80/00; B22F 3/105; E21B 34/06; B22F 5/10; F16K 5/06; F16K 3/02; F16K 27/04; B33Y 10/00; B22F 3/15

(52) U.S. Cl. CPC F16K 3/24; B33Y 10/00; B33Y 80/00; B22F 3/1055; B22F 3/15; B22F 5/10; F16K 5/0657; F16K 3/0263; F16K 27/041; E21B 34/06; B22F 2998/10; E21B 2034/002

(57) ABSTRACT

A method of manufacturing a fluid-handling component includes forming a liner via an additive manufacturing process and forming a body about the liner via a powder compaction process. The body may be coupled to the liner via diffusion bonds during the powder compaction process. The fluid-handling component may be constructed for use in a mineral extraction system.

### CROSS-REFERENCE TO RELATED APPLICATION

This application is a continuation of U.S. application Ser. No. 14/978,435 entitled “FLUID-HANDLING COMPONENTS AND METHODS OF MANUFACTURE,” filed on Dec. 22, 2015, which is hereby incorporated by reference in its entirety.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

In certain fluid-handling systems, such as mineral extraction systems, a variety of components are used to control a flow of fluid. For example, in mineral extraction systems, various valves and conduits may be used to regulate the flow of production fluids (e.g., oil, gas, or water) from a well. Such valves and conduits may contact the production fluids during mineral extraction (i.e., drilling and production) operations. Unfortunately, surfaces of these components may be subject to corrosion, erosion, and general wear (e.g., due to the production fluids).

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is a block diagram of a mineral extraction system having a fluid-handling component, in accordance with an embodiment of the present disclosure;

FIG. 2 is a perspective view of a portion of the fluid-handling component of FIG. 1 having a liner and a body, in accordance with an embodiment of the present disclosure;

FIG. 3 is a cross-sectional side view of the portion of the fluid-handling component of FIG. 2, in accordance with an embodiment of the present disclosure;

FIG. 4 is a perspective view of a liner that may be used in a choke valve, in accordance with an embodiment of the present disclosure;

FIG. 5 is a cross-sectional side view of the liner of FIG. 4 surrounded by a body, in accordance with an embodiment of the present disclosure;

FIG. 6 is a perspective view of a body that may surround the liner of FIG. 4, in accordance with an embodiment of the present disclosure;

FIG. 7 is a flow diagram of a method of manufacturing a liner for use in the fluid-handling component of FIG. 1 via an additive manufacturing process, in accordance with an embodiment of the present disclosure;

FIG. 8 is a flow diagram of a method of forming a body about a liner for use in the fluid-handling component of FIG. 1 via a powder compaction process, in accordance with an embodiment of the present disclosure; and

FIG. 9 is a block diagram of a system configured to manufacture the fluid-handling component of FIG. 1, in accordance with an embodiment of the present disclosure.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Mineral extraction systems (i.e., drilling and production systems) generally include a wide variety of pressure-containing components and/or fluid-handling components, such as various valves and conduits, which may contact fluids (e.g., production fluids) during drilling and/or production operations. In existing systems, certain surfaces (e.g., fluid-contacting surfaces) of these components may be clad with a corrosion resistant material via a welding process. Such welding processes may include a series of welding, machining, finishing, and thermal treatments, and intermittent testing and inspection steps. For example, in some cases, a forged body (e.g., valve body) having a bore may be provided. A weld inlay (e.g., a layer of corrosion-resistant material) may be applied and welded within the bore, the weld bonds may be tested for integrity, and the component may be finished and inspected (e.g., for liquid penetration). These steps are generally inefficient, complex, and/or costly, and the components produced via such welding processes may be frequently identified as noncompliant with regulatory standards during testing and final inspections.

Accordingly, the present disclosure provides embodiments of fluid-handling components, such as valves and conduits for use in a mineral extraction system, which are manufactured via additive manufacturing techniques and/or powder compacting techniques. For example, in some embodiments, the disclosed fluid-handling components may include a liner (e.g., a corrosion-resistant liner or fluid-contacting liner) constructed via an additive manufacturing technique (e.g., 3-D printing). The liner may be placed into a canister (e.g., container) of a desired shape, and a body (e.g. support structure) of the fluid-handling component may be formed within the canister and about the liner (e.g., on an outer surface of the liner) via a powder compaction process (e.g., hot isostatic pressing [HIP]). Such techniques generally provide the capability to efficiently construct fluid-handling components having a particular shape without complex and/or costly forging, welding, and/or machining steps, for example.

Using such techniques, the fluid-handling components so produced may have one or more advantageous structural features or characteristics. For example, in certain embodiments, the fluid-handling component and/or the liner within the body of the fluid-handling component may be devoid of joints (e.g., welds or welded bonds), thereby eliminating weld bond defects and/or the need for weld bond inspections and/or repairs. In certain embodiments, the liner within the body of the fluid-handling component may be devoid of iron or substantially devoid of iron (e.g., iron may penetrate less than 1 or 2 microns into the liner after application of the body about the liner and the liner is otherwise devoid of iron) at least in part because the manufacturing methods disclosed herein do not cause significant amounts of iron to transfer from the body (e.g., steel body) to the liner (e.g., nickel or other corrosion-resistant material). In certain embodiments, iron may penetrate less than 1, 2, 10, 20, 30, 40, 50, 100, 200, 300, 400, 500, 1000, 5000, or 10,000 microns into the liner after application of the body about the liner and the liner is otherwise devoid of iron. In certain embodiments, iron may penetrate between about 1 to 10,000, 2 to 1000, 10 to 500, or 20 to 100 microns into the liner 30 after application of the body 28 about the liner 30 and the liner 30 is otherwise devoid of iron. In some embodiments, iron may penetrate less than 1, 5, 10, 25, or 50 percent of a thickness (e.g., between a radially-inner surface and a radially-outer surface) of the liner. Accordingly, the liner may have a relatively high resistance to corrosion (e.g., as compared to a cladding layer formed via certain other manufacturing processes, such as welding, that result in more significant iron dilution of the cladding layer). Additionally or alternatively, in some embodiments, the liner may be relatively thin (e.g., as compared to a cladding layer formed via certain other manufacturing processes, such as welding or HIP). For example, in some embodiments, a wall of the liner may have a thickness of less than about 0.35 centimeters (cm) or other dimensions as set forth below. Furthermore, in some embodiments, the liner and/or the body may each be a single integral and gaplessly continuous piece having a uniform density and/or a homogenous material structure. In some embodiments, the liner and/or the body may be formed from segments that are joined or bonded together. To facilitate discussion, certain embodiments disclosed in detail below relate generally to valves (e.g., gate valves, ball valves, choke valves, check valves, pressure regulating valves, and the like) and conduits (e.g., hangers) of a mineral extraction system. However, it should be understood that the techniques disclosed herein may be applied to and/or adapted to form any of a variety of pressure-containing components and/or fluid-handling components (e.g., components having a surface that contacts a fluid) for use in any of a variety of systems.

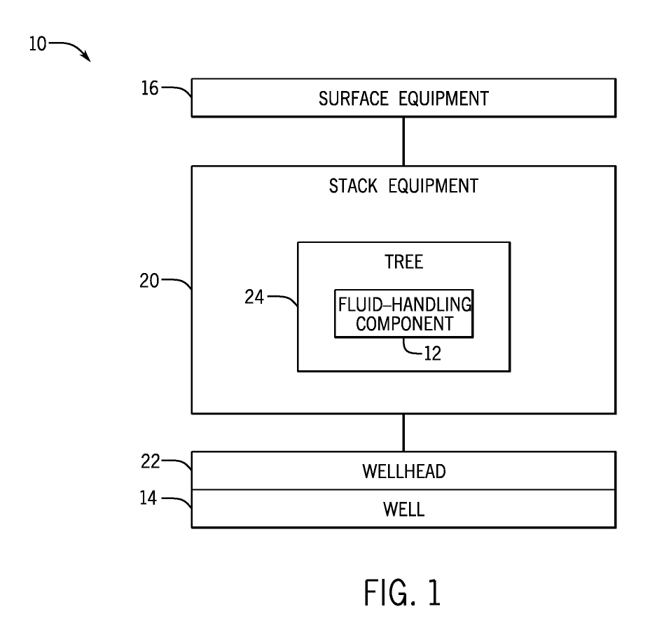

With the foregoing in mind, FIG. 1 illustrates an embodiment of a mineral extraction system 10 (e.g., hydrocarbon extraction system) having a fluid-handling component 12 (e.g., a choke valve, gate valve, ball valve, check valve, pressure regulating valve, conduit, hanger, or the like). In the illustrated embodiment, the system 10 is configured to facilitate the extraction of a resource, such as oil or natural gas, from a well 14. As shown, the system 10 includes a variety of equipment, such as surface equipment 16 and stack equipment 20, for extracting the resource from the well 14 via a wellhead 22. The surface equipment 16 may include a variety of devices and systems, such as pumps, conduits, valves, power supplies, cable and hose reels, control units, a diverter, a gimbal, a spider, and the like. As shown, the stack equipment 20 includes a production tree 24, also commonly referred to as a “Christmas tree.” The tree 24 may include fluid-handling components 12 that control the flow of an extracted resource out of the well 14 and upward toward the surface equipment 16 and/or that control the flow of injected fluids into the well 14. For example, the tree 24 may include various valves, conduits, flow meters, sensors, and so forth. While the fluid-handling component 12 is shown within the tree 24 in FIG. 1, it should be understood that the fluid-handling component 12 disclosed herein may be used in any portion of the system 10, such as the surface equipment 16, the stack equipment 20, the wellhead 22, and/or subsea equipment, for example.

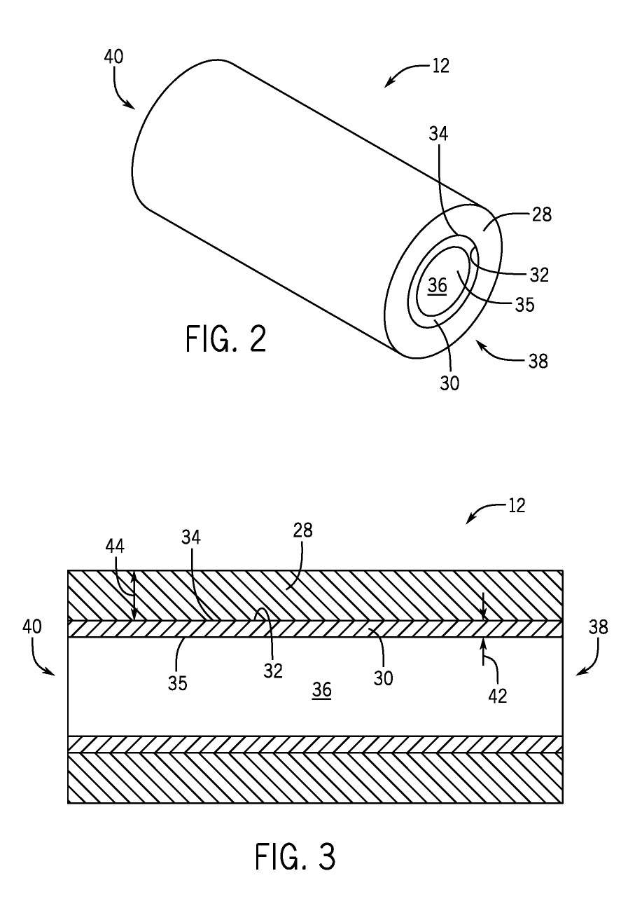

FIG. 2 is a perspective view of a portion of the fluid-handling component 12 having a body 28 (e.g., a support structure) and a liner 30 (e.g., a fluid-contacting part), in accordance with an embodiment of the present disclosure. As shown, the body 28 surrounds (e.g., circumferentially) the liner 30, and an outer surface 32 (e.g., radially-outer surface) of the liner 30 contacts an inner surface 34 (e.g., radially-inner surface) of the body 28. An inner surface 35 (e.g., radially-inner surface or fluid-contacting surface) of the liner 30 defines a bore 36 that is configured to receive and to support a flow of fluid. The body 28 and the liner 30 extend between an inlet 38 and an outlet 40 of the portion of the fluid-handling component 12, and the liner 30 is configured to block contact between the flow of fluid in the bore 36 and the inner surface 34 of the body 28.

FIG. 3 is a side cross-sectional view of the portion of the fluid-handling component 12 of FIG. 2. As shown, the outer surface 32 of the liner 30 contacts the inner surface 34 of the body 28, thereby lining the inner surface 34 of the body 28 and/or blocking contact between the flow of fluid in the bore 36 and the inner surface 34 of the body 28.

In the illustrated embodiment, the liner 30 has a thickness 42. The thickness 42 may be uniform about the liner 30, or certain portions of the liner 30 may have varying thicknesses 42 (e.g., varying by 1, 2, 3, 4, 5, 10, or more percent). In some embodiments, the thickness 42 may be less than approximately 0.2, 0.25, 0.3, 0.35, 0.4, 0.45, 0.5, 0.55, 0.6, 0.65, 0.7, 0.75, or 0.8 cm. In some embodiments, the thickness 42 may be between approximately 0.2 to 0.8, 0.25 to 0.47, or 0.3 to 0.6 cm. The thickness 42 of the liner 30 may be less than a thickness 44 of the body 28 (e.g., 10, 20, 30, 40, 50, 60, 70, 80, 90 or more percent less). In some embodiments, the liner 30 may have a porosity less than or equal to approximately 0.5, 1, 2, 3, 4, or 5 percent (e.g., where 100 percent is a baseline for a porous material). As shown, the liner 30 is a single integral and gaplessly continuous piece and is devoid of joints (e.g., welds or welded bonds). In certain embodiments, the body 28 may be a single integral and gaplessly continuous piece and/or may be devoid of joints (e.g., welds or welded bonds). In certain embodiments, the liner 30 and/or the body 28 may have a homogenous material structure and/or a uniform density. In certain embodiments, the liner 30 and/or the body 28 may be formed from multiple segments (e.g., separate portions or pieces) that are joined or bonded together (e.g., via welds, fasteners, or the like), and one or all of the multiple segments may be have any of the characteristics disclosed herein and/or be formed via the processes disclosed herein. For example, although shown as a single piece in FIG. 3, in certain embodiments, the liner 30 may include multiple liner segments (e.g., some or all of which are formed via an additive manufacturing process and have the characteristics described herein, such as a complex shape, porosity, etc.) that are coupled (e.g., bonded, welded, or fastened) at respective ends to enable manufacturing of the liner 30 of a desirable shape. In some cases, the multiple segments may enable formation of a shape and/or a length where the desirable shape and/or length exceeds the shape and/or length enabled by equipment used in the additive manufacturing process. The coupled liner segments forming the liner 30 may subsequently be surrounded by the body 28 (e.g., via a single powder compacting process). In certain embodiments, the outer surface 32 of the liner 30 may be coupled (e.g., bonded or fixed) to the inner surface 34 of the body 28 (e.g., via diffusion bonds). In certain embodiments, the inner surface 34 of the body 28 and the outer surface 32 of the liner 30 (e.g., at the interface) may include surface features (e.g., grooves, protrusions, structural ribs, surface texture, recesses, or the like) that may facilitate coupling the body 28 to the liner 30, retention of the body 28 about the liner 30, rigidity of the fluid-handling component 12, or the like. Furthermore, in certain embodiments, the liner 30 may be devoid of iron or substantially devoid of iron (e.g., iron may penetrate less than 1 or 2 microns radially inward from the outer surface 32 of the liner 30 after application of the body 28 about the liner 30 and the liner 30 is otherwise devoid of iron). In certain embodiments, iron may penetrate less than 1, 2, 10, 20, 30, 40, 50, 100, 200, 300, 400, 500, 1000, 5000, or 10,000 microns into the liner 30 after application of the body 28 about the liner 30 and the liner 30 is otherwise devoid of iron. In certain embodiments, iron may penetrate between about 1 to 10,000, 2 to 1000, 10 to 500, or 20 to 100 microns into the liner 30 after application of the body 28 about the liner 30 and the liner 30 is otherwise devoid of iron. In some embodiments, iron may penetrate less than 1, 5, 10, 25, or 50 percent of a thickness (e.g., between a radially-inner surface and a radially-outer surface) of the liner.

The liner 30 and the body 28 described herein may be manufactured from any of a variety of materials. In some embodiments, the liner 30 may be manufactured from a corrosion resistant metal alloy, such as a nickel-based alloy. More specifically, in some embodiments, the liner 30 may be manufactured from nickel alloy 625, although any suitable material, such as a chrome-based alloy (e.g., cobalt chrome) or other similar alloys, capable of being constructed and shaped by an additive manufacturing process may be utilized. In some fluid-handling components 12, the liner 30 may be formed from a ceramic or a composite material. In some embodiments, the body 28 may be manufactured from steel (e.g., 4140 steel, 22 chrome duplex, 25 chrome duplex, or the like), although any suitable material, such as other similar alloys, capable of being constructed and shaped by a powder compacting process may be utilized. Various combinations of materials are also contemplated in the structure of the liner 30 and/or the body 28.

As discussed in more detail below, in certain embodiments, the liner 30 may be formed via an additive manufacturing process and the body 28 may subsequently be formed about the liner 30 via a powder compacting process. In general, additive manufacturing techniques may involve applying a source of energy, such as a laser or electron beam, to deposited powder layers in order to grow (i.e., form) a part having a particular shape and features. In general, powder compacting processes may involve placing a powder within a canister (e.g., high pressure containment vessel or container) and applying heat and/or pressure to the powder to consolidate the powder to form a compact solid object. In the disclosed embodiments, the powder compacting process may cause the body 28 to form about the liner 30 and to couple to the liner 30 (e.g., via diffusion bonds). Such processes may enable construction of the fluid-handling component 12, the liner 30, and/or the body 28 having certain features disclosed herein, which are costly, impractical, and/or cannot be made using other manufacturing techniques, such as welding techniques.

While the portion of the fluid-handling component 12 and its parts (e.g., the body 28 and liner 30) are generally cylindrical in FIGS. 2 and 3 to facilitate discussion, it should be understood that the fluid-handling component 12 and its parts may have any of a variety shapes and/or cross-sectional shapes (e.g., rectangular, conical, frustro-conical, etc.). In particular, the additive manufacturing process and/or the powder compacting process as disclosed herein enable construction of a variety of custom parts having complex geometries, curvatures, and features. In some embodiments, the liner 30 and the body 28 may having varying respective thicknesses 42, 44, widths, and/or diameters (e.g., inner diameter 54). The liner 30 and body 28 may have respective final shapes such that the liner 30 (e.g., with its final shape) could not be inserted into the body 28 (e.g., with its final shape). Furthermore, while the liner 30 is shown to be annular and includes the bore 36, it should be understood that the liner 30 may not be annular, but rather may be non-annular and/or planar, and the body 28 may be applied to any suitable surface or surfaces of the liner 30 via the powder compaction techniques disclosed herein (e.g., the liner 30 may be placed in a canister and powder formed into the body 28 onto the surface of the liner 30 via the powder compaction process). In some embodiments, the liner 30 and/or the body 28 may include surface features. For example, the outer surface 32 of the liner 30 may include one or more radially-extending notches, recesses, protrusions, slots, surface texture, and/or structural ribs. The surface features may extend about (e.g., circumferentially) or axially along the liner 30. The inner surface 34 of the body 28 may be formed about the surface features and thus may have corresponding shapes (e.g., the interface between the liner 30 and the body 28 may include a key-fit structure). In some cases, the surface features may facilitate bonding between the liner 30 and the body 28.

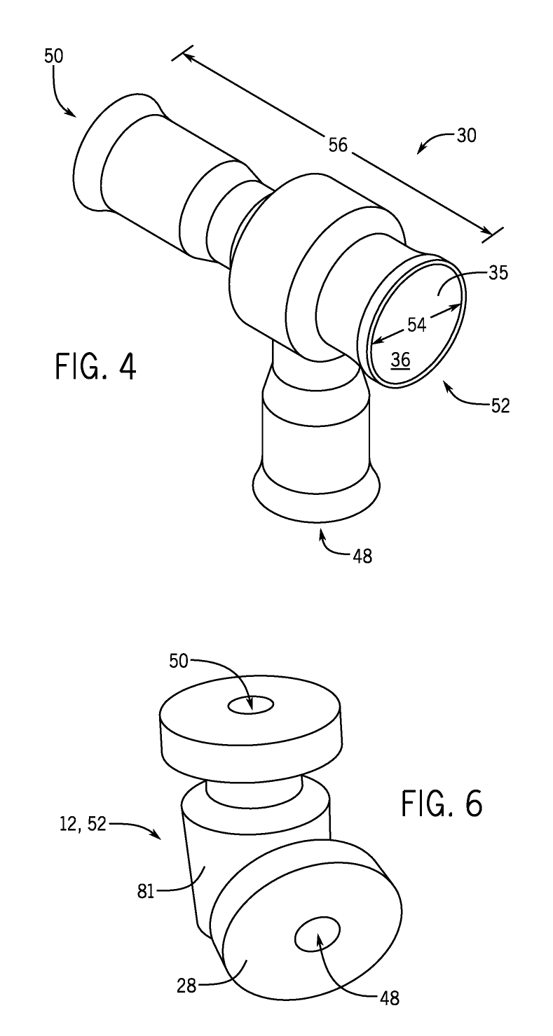

By way of another example, FIG. 4 is a perspective view of the liner 30 configured for use in a choke valve type of fluid-handling component 12. As such, the liner 30 includes a fluid inlet 48, a fluid outlet 50, and an opening 52 configured to be positioned at a bonnet end of the choke valve and to receive a valve member (e.g., a plug) that moves relative to the liner 30 to adjust a flow of fluid through the choke valve. The liner 30 is generally annular and extends between the inlet 48, the outlet 50, and the opening 52. The inner surface 35 of the liner 30 defines the bore 36 that is configured to receive and to support a flow of fluid between the inlet 48 and the outlet 50. The liner 30 may have a complex shape that cannot be efficiently constructed using conventional manufacturing techniques. For example, a diameter 54 (e.g., inner diameter or diameter of the bore 36 defined by the liner 30) of the liner 30 may vary along a length 56 of the liner 30, the thickness 42 may be less than approximately 0.2, 0.25, 0.3, 0.35, 0.4, 0.45, or 0.5 cm, and/or the thickness 42 may vary about the liner 30. The liner 30 shown in FIG. 4 may also have any of the features or characteristics described above with respect to FIGS. 1-3. For example, in certain embodiments, the liner 30 may be devoid of joints (e.g., welds or welded bonds), the liner 30 may be devoid of iron or substantially devoid of iron, the liner 30 may be a single piece or be formed from multiple segments each having a uniform density and/or a homogenous material structure.

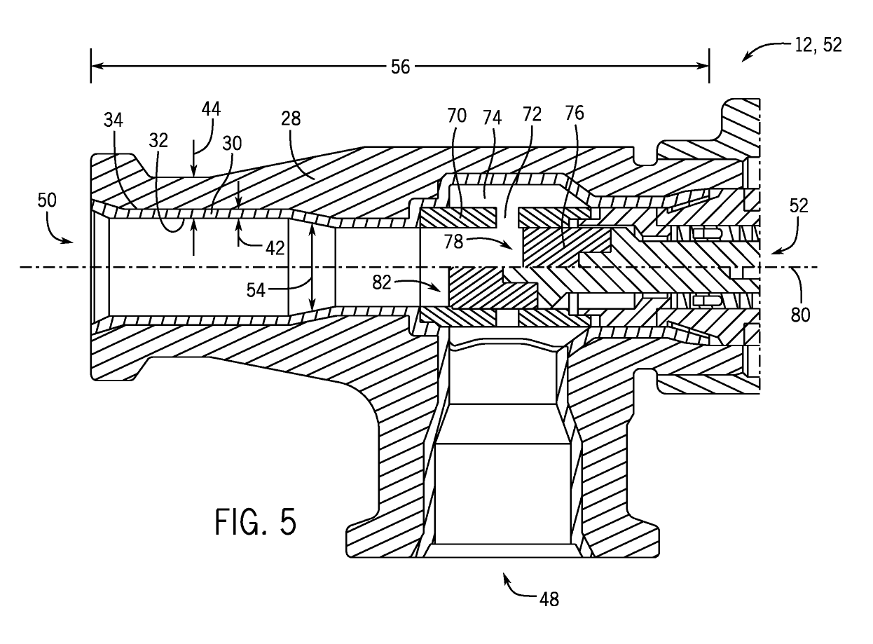

FIG. 5 is a side cross-sectional view of the liner 30 of FIG. 4 within the body 28 of a choke valve 52. As noted above, it should be understood that the liner 30 and the body 28 may have any suitable shape or configuration for use in any of a variety of fluid-handling components 12, such as gate valves, ball valves, check valves, pressure regulating valves, conduits, hangers, or the like. As shown, the outer surface 32 of the liner 30 contacts the inner surface 34 of the body 28, thereby lining (e.g., protecting) the inner surface 34 of the body 28 and/or blocking a flow of fluid through the choke valve 52 (e.g., from the inlet 48 to the outlet 50) from contacting the inner surface 34 of the body 28. In the illustrated embodiment, the liner 30 lines the inner surface 34 of the body 28 such that no part of the body 28 contacts fluid flowing through the choke valve 52 when the choke valve 52 is fully assembled and/or in use. The liner 30 and/or the body 28 shown in FIG. 5 may also have any of the features or characteristics described above with respect to FIGS. 1-4. For example, the diameter 54 of the liner 30 may vary along the length 56 of the liner 30, and/or the thickness 42 may be less than the thickness 44 and/or less than approximately 0.2, 0.25, 0.3, 0.35, 0.4, 0.45, or 0.5 cm.

As discussed in more detail below, the liner 30 may be constructed via an additive manufacturing technique and the choke valve 52 may be constructed by forming the body 28 about the liner 30 via a powder compacting process. After application of the body 28 about the liner 30, additional components of the choke valve 52 may be coupled to the body 28 and/or the liner 30. For example, as shown, a cage 70 having one or more openings 72 (e.g., passageways, conduits, or holes) is positioned within a cavity 74 of the liner 30. A plug 76 may extend through the opening 52 of the liner 30 and may move relative to the liner 30 and the cage 70 (e.g., via an actuator), thereby adjusting a flow of fluid between the inlet 48 and the outlet 50. The plug 76 is shown in two positions above and below an axis 80 in FIG. 3. In particular, the plug 76 may move between an open position 78 in which the plug 76 does not block the flow of fluid through the one or more openings 72, as shown above the axis 80, and a closed position 82 in which the plug 76 blocks the flow of fluid through the one or more openings 72, as shown below the axis 80.

FIG. 6 is a perspective view of an embodiment of the body 28 of the choke valve 52 formed about the liner 30 via a powder compacting process. As shown, the body 28 is a single piece that extends from the inlet 48 to the outlet 50 of the choke valve 52. An outer surface 81 of the body 28 may correspond to a shape of the canister used during the powder compacting process.

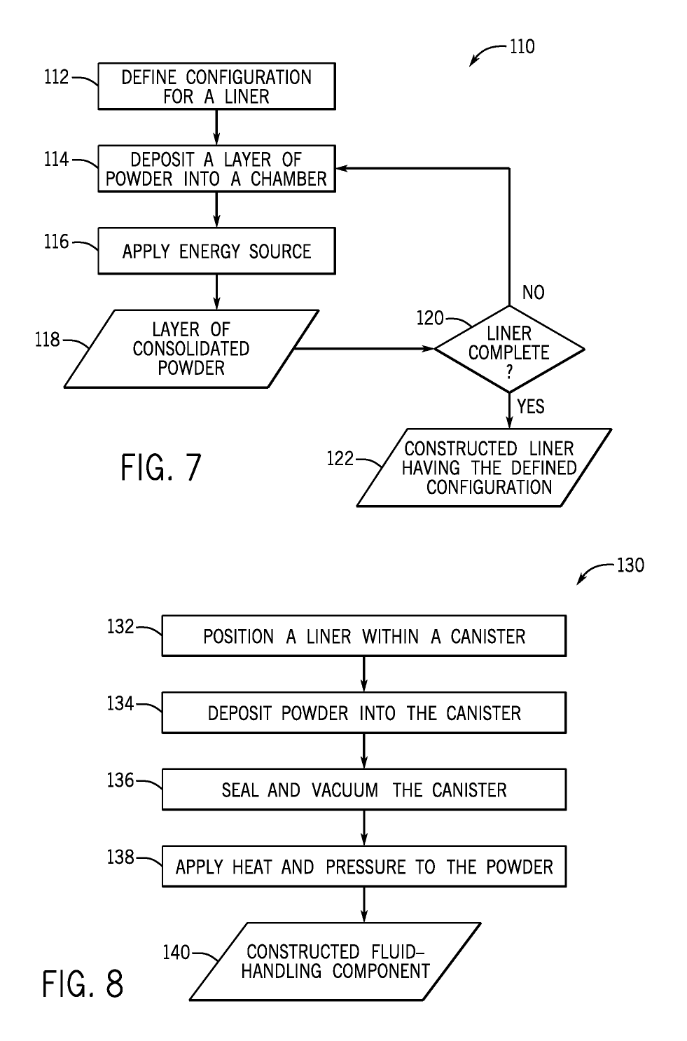

With the foregoing in mind, FIG. 7 is a flow diagram of a method 110 for constructing the liner 30 of the fluid-handling component 12 (e.g., the choke valve 52 or any other fluid-handling component 12). The method 110 includes steps for constructing the liner 30 using an additive manufacturing process (e.g., 3-D printing).

The method 110 may be performed by an additive manufacturing system, which may include a controller (e.g., electronic controller), a processor, a memory device, a user interface, and/or an energy source. The method 110 includes defining a particular configuration or shape for the liner 30, in step 112. The configuration may be programmed by an operator into an additive manufacturing system by using a specialized or general purpose computer having the processor, for example. The defined configuration may have any of the shapes and features described above. For example, the thickness 42 of the wall 40 of the liner 30 may be less than approximately 0.2, 0.25, 0.3, 0.35, 0.4, 0.45, or 0.5 cm or between approximately 0.2 to 0.5, 0.25 to 0.45, or 0.3 to 0.4 cm.

In step 114, a layer of powder (e.g., a metal powder, such a nickel-based powder) is deposited into a chamber, such as a vacuum chamber. Any of a variety of materials may used in any suitable combination, including those described in detail above with respect to FIG. 3. In step 116, an energy source, such a laser or electron beam, for example, is applied to the deposited layer of powder to melt or otherwise consolidate the powder. As shown at block 118, a consolidated layer having a cross-sectional shape corresponding to the configuration defined in step 112 is formed. The processor or operator may determine whether the liner 30 is incomplete or complete, in step 120. If the part is incomplete, then steps 114 and 116 are repeated to produce layers of consolidated powder having cross-sectional shapes corresponding to the defined confirmation or model until construction of the liner 30 is complete. Thus, the energy source is applied to melt or otherwise consolidate each newly deposited powder layer until the final product is complete and the liner 30 having the defined configuration is produced, as shown in step 122. In certain embodiments, the liner 30 constructed at step 122 via the method 110 is devoid of joints (e.g., welds or welded bonds), has a homogenous material structure, and/or a uniform density. In some embodiments, the liner 30 constructed at step 122 via the method 110 may be used in the fluid-handling component 12 and/or may be coupled to the body 28 via the powder compacting process without further machining or smoothing of the liner 30.

With the foregoing in mind, FIG. 8 is a flow diagram of a method 130 for constructing the fluid-handling component 12 (e.g., the choke valve 52 or any other fluid-handling component 12). In particular, the method 130 includes steps for constructing the body 28 about the liner 30 using a powder compacting process (e.g., HIP). The method 130 may be performed by a powder compacting system, which may include a controller (e.g., electronic controller), a processor, a memory device, a user interface, a pressure source, a heat source, and/or a canister. As discussed in more detail below, in some embodiments, the additive manufacturing system and the powder compacting system may be part of the same system (e.g., having common or independent electronic controllers) to facilitate construction of the fluid-handling component 12.

The method 130 includes positioning the liner 30 (e.g., a previously formed liner) within a canister, in step 132. In some embodiments, the liner 30 may be produced via an additive manufacturing process, such as the method 110 of FIG. 7. In certain embodiments, the liner 30 may be produced via another suitable technique that enables construction of the liner 30 having the features disclosed above, such as a complex shape, uniform density, the thickness 42, and the like. The liner 30 so produced may have characteristics (e.g., density and/or porosity) that enable the liner 30 to maintain its shape and/or support formation of the body 28 during the powder compaction process. In some embodiments, the liner 30 may be provided and positioned within the canister in its final shape (e.g., the shape of the liner 30 as inserted into the canister matches the shape of the liner 30 after formation of the body 28 about the liner 30 and/or during use of the fluid-handling component 12). Thus, in some embodiments, the liner 30 may not be finished (e.g., machined) after formation of the body 28 about the liner 30, thereby reducing costs and time, for example.

In step 134, a powder (e.g., a metal powder, such a steel powder) is deposited into the canister about the liner 30 (e.g., between the outer surface 32 of the liner 32 and a wall of the canister). The powder may be any of a variety of materials, including those described in detail above with respect to FIG. 3. In step 136, the canister is sealed and vacuumed. In step 138, heat and/or pressure is applied to the powder within the canister to consolidate the powder to form the body 28 about the liner 30. For example, heat and/or pressure may be applied to the canister via a heat source and/or a pressure source (e.g., an autoclave furnace), and a wall of the canister may impart pressure to the powder. The heat and/or pressure may cause the body 28 and the liner 30 to bond to one another (e.g., via diffusion bonds at an interface between the body 28 and the liner 30). In certain embodiments, the temperature applied to the powder within the canister may be approximately 1050 to 1100 degrees Celsius, and the hydrostatic pressure within the canister may be approximately 400 to 450 MPa. However, any suitable temperature and/or pressure may be utilized to cause formation of the body 28 about the liner 30. For example, in some embodiments, the temperature may be between approximately 900 to 1200, 950 to 1150, or 1000 to 1100 degrees Celsius and/or the pressure may be approximately 300 to 600, 350 to 550, or 400 to 500 MPa. Through these steps, the fluid-handling component 12 having the body 28 and the liner 30 is constructed at block 140. Upon completion of the method 130, the liner 30 may be devoid of iron or substantially devoid of iron, the liner 30 and/or the body 28 may have a uniform density and/or a homogenous material structure, and/or the liner 30 and the body 28 may be coupled to one another via diffusion bonds, for example.

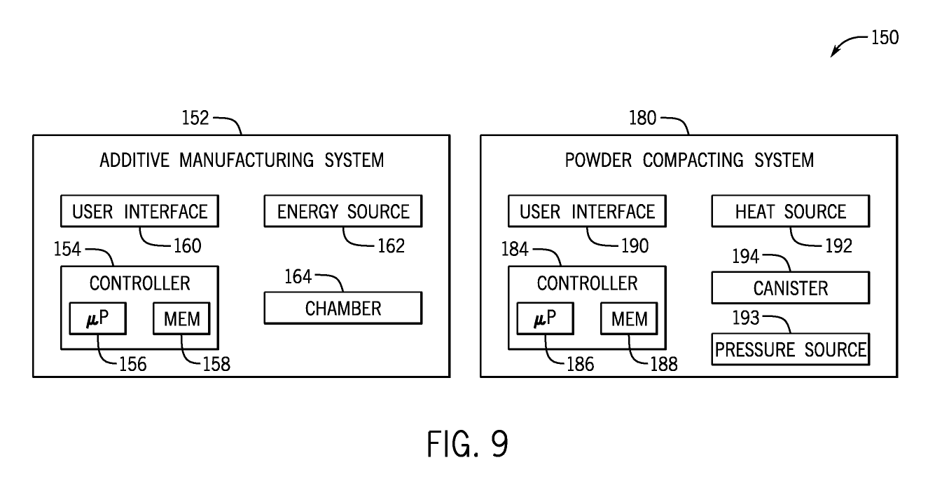

FIG. 9 is a block diagram of an embodiment of a manufacturing system 150 that may be used to construct the fluid-handling component 12. In the illustrated embodiment, the manufacturing system 150 includes an additive manufacturing system 152 and a powder compacting system 180. As shown, the additive manufacturing system 152 and the powder compacting system 180 may be configured to operate separately from one another. For example, in some such embodiments, the additive manufacturing system 152 may be used to construct the liner 30 (e.g., in a first manufacturing facility), and the powder compacting system 180 may be used to separately construct the body 28 about the liner 30 (e.g., in a second manufacturing facility).

As shown, the additive manufacturing system 152 includes a controller 154 (e.g., electronic controller) having a processor 156 and a memory device 158. The additive manufacturing system 152 may also include a user interface 160, an energy source 162, and a chamber 164, which may be used to carry out the steps of the method 110 of FIG. 7 to form the liner 30. The powder compacting system 180 includes a controller 184 having a processor 186 and a memory device 188. The powder compacting system 180 may also include a user interface 190, a heat source 192, a pressure source 193, and a canister 194, which may be used to carry out the steps of the method 130 of FIG. 8 to form the body 28 about the liner 30.

Although shown as separate systems, in some embodiments, the additive manufacturing system 152 and the powder compacting system 180 may be communicatively coupled to one another and/or may share a common controller (e.g., electronic controller). In some such cases, the system 150 may enable construction of the fluid-handling component 12 in a series of consecutive steps and/or in a single manufacturing facility. For example, the additive manufacturing system 152 may be used to construct the liner 30. Upon completion of the liner 30, the operator may position the liner 30 in the canister 194 of the powder compacting system 180, and the operator may then cause the powder compacting system 180 (e.g., via user input to the system 180) to form the body 28 about the liner 30. In some embodiments, certain steps may be automated or performed automatically by the controller. For example, upon completion of the liner 30 by the additive manufacturing system 152, a device controlled by the controller may position the liner 30 within the canister 194 of the powder compacting system 180 and subsequently cause the powder compacting system 180 to form the body 28 about the liner 30.

In certain embodiments, an additive manufacturing system, such as the additive manufacturing system 152, may be used to construct the canister 194. For example, the steps 112-122 of the method 110 set forth in FIG. 7 may be used to construct the canister 194 having the desired shape for forming the body 28 about the liner 30. The additive manufacturing process may enable efficient construction of the canister 194.

In certain embodiments, the controllers 154, 184 are electronic controllers having electrical circuitry configured to process data from various components of the system 150, for example. In the illustrated embodiment, each of the controllers 154, 184 includes a respective processor, such as the illustrated microprocessors 156, 186, and a respective memory device 158, 188. The controllers 154, 184 may also include one or more storage devices and/or other suitable components. By way of example, the processor 184 may be used to execute software, such as software for controlling the heat source 192, and so forth. Moreover, the processors 154, 184 may include multiple microprocessors, one or more “general-purpose” microprocessors, one or more special-purpose microprocessors, and/or one or more application specific integrated circuits (ASICS), or some combination thereof. For example, the processors 154, 184 may include one or more reduced instruction set (RISC) processors.

The memory devices 156, 186 may include a volatile memory, such as random access memory (RAM), and/or a nonvolatile memory, such as ROM. The memory devices 156, 186 may store a variety of information and may be used for various purposes. For example, the memory devices 156, 186 may store processor-executable instructions (e.g., firmware or software) for the processors 154, 184 to execute, such as instructions for controlling the energy source 162 or the heat source 192. The storage device(s) (e.g., nonvolatile storage) may include read-only memory (ROM), flash memory, a hard drive, or any other suitable optical, magnetic, or solid-state storage medium, or a combination thereof.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method of manufacturing a fluid-handling component, the method comprising:
forming a liner via an additive manufacturing process; and
forming a body about the liner via a powder compaction process.

2. The method of claim 1, wherein the liner comprises a thickness of less than 0.35 centimeters.

3. The method of claim 1, comprising coupling the body to an outer surface of the liner via diffusion bonds during the powder compaction process.

4. The method of claim 1, wherein the liner maintains a shape during formation of the body about the liner during the powder compaction process.

5. The method of claim 1, wherein forming the liner via the additive manufacturing process comprises defining a configuration for the liner, depositing a powder into a chamber, applying an energy source to the deposited power, and consolidating the powder into a final shape corresponding to the defined configuration for the liner.

6. The method of claim 1, wherein forming the body about the liner via the powder compaction process comprises placing the liner within a container, placing a powder into the container, sealing the container, and applying heat and pressure to the powder within the container to cause the powder to bond to the liner and to form the body.

7. The method of claim 1, wherein the fluid-handling component comprises one of a choke valve, a gate valve, or a ball valve.

8. A method of manufacturing a fluid-handling component, the method comprising:
placing an annular liner within a container, wherein the annular liner comprises a desired shape generated via an additive manufacturing process; and
forming a body about the annular liner via a powder compaction process.

9. The method of claim 8, wherein the annular liner comprises a thickness of less than 0.35 centimeters.

10. The method of claim 8, comprising coupling the body to the annular liner via diffusion bonds during the powder compaction process.

11. The method of claim 8, wherein the liner is devoid of joints.

12. The method of claim 8, wherein forming the body about the annular liner via the powder compaction process comprises placing a powder into the container, sealing the container, and applying heat and pressure to the powder within the container to cause the powder to bond to the annular liner and to form the body.

13. The method of claim 8, wherein the fluid-handling component comprises one of a choke valve, a gate valve, or a ball valve.

14. The method of claim 8, wherein the liner comprises a nickel alloy and the body comprises a steel alloy.

15-20. (canceled)

21. The method of claim 1, wherein the liner is an annular structure that defines a fluid flow path, and forming the body about the liner comprises forming an annular body that contacts and circumferentially surrounds a radially-outer surface of the liner.

22. The method of claim 21, wherein the fluid flow path extends between a fluid inlet and a fluid outlet, and an inner diameter of the liner varies along the fluid flow path between the fluid inlet and the fluid outlet.

23. The method of claim 22, wherein the liner comprises a thickness defined between an inner wall and an outer wall of the liner, and the thickness of the liner is less than 0.35 centimeters along an entirety of the fluid flow path between the fluid inlet and the fluid outlet.

24. The method of claim 21, wherein the liner and the body comprise respective final shapes such that the liner in its final shape after formation via the additive manufacturing process could not be inserted into the body in its final shape after formation via the power compaction process.

25. The method of claim 1, wherein the liner defines a fluid flow path and is a gaplessly continuous one-piece structure that extends between a fluid inlet of the body, a fluid outlet of the body, and an opening in the body that is configured to receive an adjustable valve member.

26. The method of claim 1, wherein the liner defines a fluid flow path and comprises a fluid inlet configured to receive a fluid, a fluid outlet configured to direct the fluid out of the liner, and at least one bend positioned between the fluid inlet and the fluid outlet.
